(19) United States
(12) Patent Application Publication
(10) Pub. No.: US 2003/0028470 A1
(43) Pub. Date: Feb. 6, 2003

(54) Method for providing anonymous on-line transactions

(75) Inventor: Rabindranath Dutta, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY (US)

(21) Appl. No.: 09/915,439

(22) Filed: Jul. 26, 2001

(51) Int. Cl. G06F 17/60

(52) U.S. Cl. 705/37; 705/26

(57) ABSTRACT

A system and method for providing anonymous on-line transactions through a networked aggregate exchange server are provided. A request may be received at a certificate authority for an enhanced certificate. The certificate authority may determine whether the request qualifies for a certificate. The certificate authority may issue the certificate to a requester, if the request qualifies. An aggregate exchange server may receive an offer from a supplier with a certificate. The exchange server may receive a bid from a purchaser with a certificate. The exchange server may determine whether the purchaser bid and the supplier offer match. The exchange server may send the supplier the purchaser's enhanced certificate and may send the purchaser the supplier's enhanced certificate, if a match exists. The exchange server may receive agreement of the supplier and purchaser. Subsequently, the aggregate exchange server may anonymously execute the transaction.

### FIELD OF INVENTION

The present invention generally relates to a method for a networked aggregate exchange server for providing anonymous on-line transactions.

### BACKGROUND OF THE INVENTION

As the use of the Internet as a medium for commerce continues to increase, the need for a user to maintain anonymity becomes a more serious concern. The increased incidence of identity theft and fraud that are targeted toward Internet users is demonstrative of the need to protect the user's identity. Presently a purchaser using the Internet to make on-line transactions must do so at the expense of providing personal information either directly or indirectly to facilitate a transaction for goods and services. There have however, been several attempts to provide remedies that resolve this issue. The apparent shortcoming with these remedies is that they require the purchaser's identity to be revealed to a supplier or to an exchange, in order to validate the transaction. Identification disclosure is a necessity when using a third party financial institution to facilitate payment for an on-line purchase. Financial institutions often use separate verification systems than those used by a referring on-line exchange and may force the purchaser to reveal his identity to several entities. Further, the purchaser's identity may be captured by other entities involved in facilitating the transaction, such as delivery agents, insurers and government entities. In some instances, captured identities may occur by passing cookies with or without the purchaser's knowledge.

There have been similar concerns for suppliers to protect their identification from entities that may misrepresent their products and services, or wish to commit other fraudulent acts. In some instances a perpetrator may present them self as a purchaser for the supplier's goods and services in order to obtain identification information. The present methods of providing anonymity are unable to protect suppliers from such fraud as the perpetrator may use the exchange and conduct a legitimate purchase, thus gaining the identity of the supplier. Upon discovering the identity, the perpetrator may flood the exchange with dummy orders to manipulate the supplier's market position or the commodities price.

Another shortcoming of the present methods of providing anonymity to the supplier and the purchaser is that as these methods enhance their security features, they fail to provide enough information to the supplier and purchaser to transact business comfortably. There may be a concern on both the purchaser's and the supplier's behalf as to the credibility of the other party. As these methods approach a standard of absolute anonymity, the confidence in the reliability of the transaction by the involved parties is inversely proportional. Therefore, it would be desirable to have a system that overcomes the above disadvantages and shortcomings, as well as other disadvantages.

### SUMMARY OF THE INVENTION

One aspect of the invention provides a method for performing an anonymous online transaction. A request for an enhanced certificate is received from a requester at a certificate authority server. It is determined whether the requester qualifies for the enhanced certificate. If the requester qualifies, the requester is issued an enhanced certificate from the certificate authority server. An offer from a supplier with a supplier enhanced certificate is received at an aggregate exchange server. A bid from a purchaser with a purchaser enhanced certificate is received at the aggregate exchange server. It is determined whether the bid matches the offer. If the bid matches the offer, the supplier is sent the purchaser enhanced certificate and the purchaser is sent the supplier enhanced certificate from the exchange server. An agreement of the matched supplier and purchaser is received at the exchange server to execute the transaction.

The certificate authority server may comprise the aggregate exchange server. The enhanced certificate may comprise financial data, credit rating data, financial routing data and identification data. Issuing the requestor an enhanced certificate may comprise implementing at least one security feature. The security feature may be selected from a group consisting of a user password, a public key cryptograph, a digital signature, and an XML based security standard. A hyperlink may be provided to the aggregated exchange server wherein the hyperlink comprises the certificate request. The hyperlink may be provided on a web site for access by the requestor. A portion of requester financial information may be verified with an outside server. Verifying the portion of requester financial information may comprise determining eligibility for an enhanced certificate. The requester financial information may be updated.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a system for a networked aggregate exchange server for providing anonymous on-line transactions, in accordance with the invention;

FIG. 2 is an illustration of one embodiment of an enhanced certificate for providing anonymous on-line transactions, in accordance with the invention;

FIG. 3A is a block diagram illustrating one embodiment of a networked aggregate exchange server for providing anonymous on-line transactions, in accordance with the invention;

FIG. 3B, FIG. 3C, FIG. 3D and FIG. 3E are examples of tables for the operation of one embodiment of the networked aggregate exchange server shown in FIG. 3A for providing anonymous on-line transactions, in accordance with the invention;

FIG. 4 is a flowchart of one embodiment of a routine of a certificate authority server for providing anonymous on-line transactions, in accordance with the invention; and

FIG. 5 is a flowchart of one embodiment of an aggregate exchange server for providing anonymous on-line transactions, in accordance with the invention.

### DETAILED DESCRIPTION OF THE PRESENTLY PREFERRED EMBODIMENTS

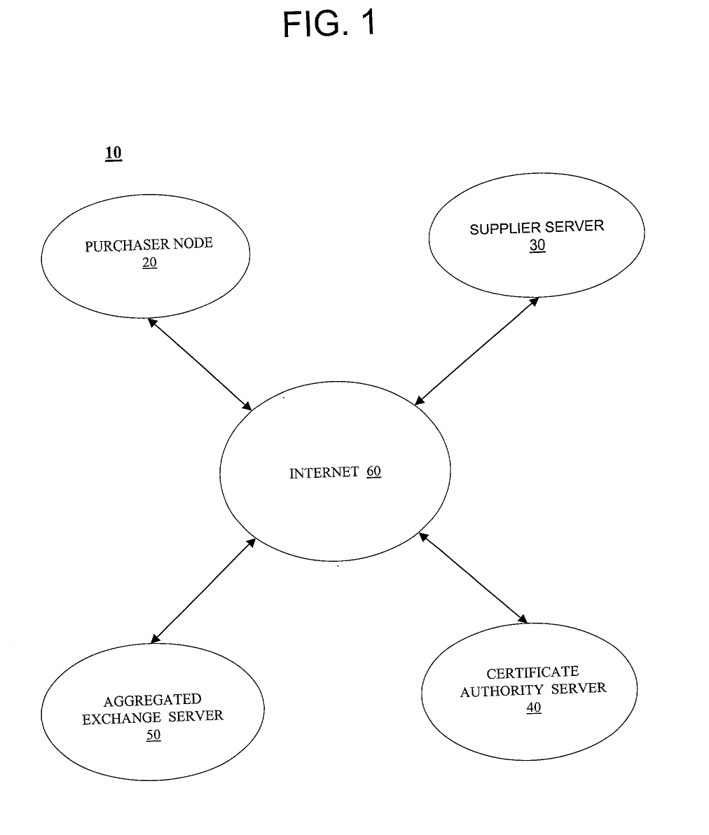

Illustrated in FIG. 1 is one embodiment of a system for a networked aggregate exchange server for providing anonymous on-line transactions in accordance with the present invention, as is shown at numeral 10. The purchaser and supplier information may for example be comprised of coded itemized charges for goods and services, shipping costs, payment terms, quality specifications, availability dates, required date of delivery, enhanced certificate ID number, bid and purchase price. The network aggregate exchange server system 10 may include a purchaser node 20, a supplier server 30, a certificate authority server 40, an exchange server 50 and Internet 60. In another embodiment, the system 10 may be any of a local area network, intranet, wide area network, or a virtual private network. The system 10 may receive purchaser requests for goods and services using an enhanced certificate to provide anonymity via the Internet 60 from the purchaser node 20. The purchaser node 20 may utilize any personal computer, personal digital assistant, digital telephone or any device known in the art capable of communicating over the Internet 60 to request good and services using enhanced certificates. The purchaser node 20 may be operably connected to the Internet 60. The Internet 60 may route any number of digital signals to any of a plurality of server site addresses via various telecommunication means over a wide area network (WAN) such as the World Wide Web. Any commercially available Internet service provider (ISP) known in the art providing access to the World Wide Web, may access the Internet 60. The Internet 60 may receive and direct the purchaser's request for goods and service using the enhanced certificate to the aggregated exchange server 50.

In another embodiment of the invention, the system 10 may receive and direct requests for enhanced certificates to the certificate authority server 40 from the purchaser and supplier via the Internet 60 from the purchaser node 20 and the supplier server 30. The purchaser node 20 may be any personal computer, personal digital assistant, digital telephone or any device capable of communicating over the Internet 60 known in the art to transmit and receive enhanced certificates. The purchaser node 20 may be operably connected to the Internet 60. The supplier server 30 may be any computer server capable of routing digital signals to any other computer via the Internet 60, intranet, local area network or any other network using any telecommunication means, known in the art to send and receive requests from enhanced certificates. The supplier server 30 may be operably connected to the Internet 60 for receiving and directing requests for enhanced certificates to the certificate authority server 40. The Internet 60 subsequently, may receive and direct purchaser and supplier requests for enhanced certificates to the certificate authority server 40 from the purchaser node 20 and the supplier server 30.

The system 10 may receive an offer of goods and services with the supplier's enhanced certificate via the Internet 60 from the supplier server 50. The supplier server 50 may be any computer server capable of routing digital signals to any other computer via the Internet 60, intranet, local area network or any other network using any telecommunications means, known in the art to send an offer for goods and services. The supplier server 30 may be operably connected to the Internet 60. The Internet 60 may receive and direct offers for goods and services with the supplier's enhanced certificate to the aggregate exchange server 50. The Internet 60 subsequently, may receive and direct supplier offers to the aggregate exchange server 50 from the supplier server 30.

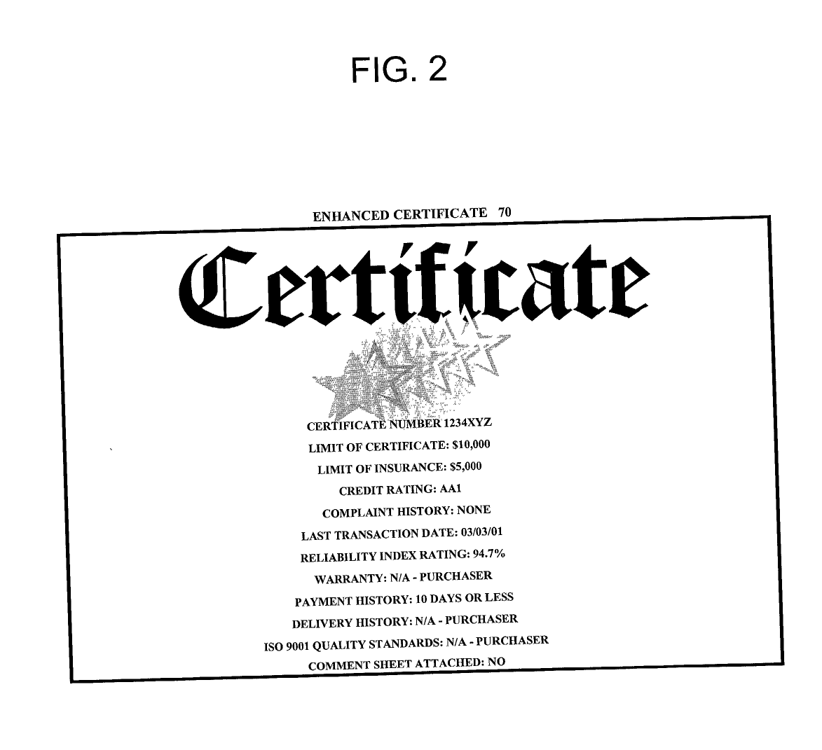

FIG. 2 illustrates one embodiment of an enhanced certificate 70 to provide anonymous on-line transactions, in accordance with the present invention. The enhanced certificate 70 may be any certificate issued by any certificate authority using any encryption standard such as X.509 Public Key, Simple Public Key Infrastructure (SPKI), Pretty Good Privacy (PGP) or Attribute Class as further described in Understanding Public-Key Infrastructure: Concepts, Standards and Deployment Considerations, C. Adams and S. Lloyd, McMillan Technical Publishing 1999, Library of Congress Catalogue Number 99-60204. The enhanced certificate may also contain financial rating data, a reliability index, insurance data, and quality and warranty data. The enhanced certificate may be verified by a third party or by the aggregate exchange server 50. Subsequent to the selection of a match by the aggregate exchange server 50, a prospective purchaser and supplier may review this data to determine if there is agreement with the match. The exchange of the enhanced certificates of the purchaser and the supplier may provide a more secure anonymous transaction. The enhanced certificate may also contain financial information such as banking data and credit authorizations to facilitate the transaction.

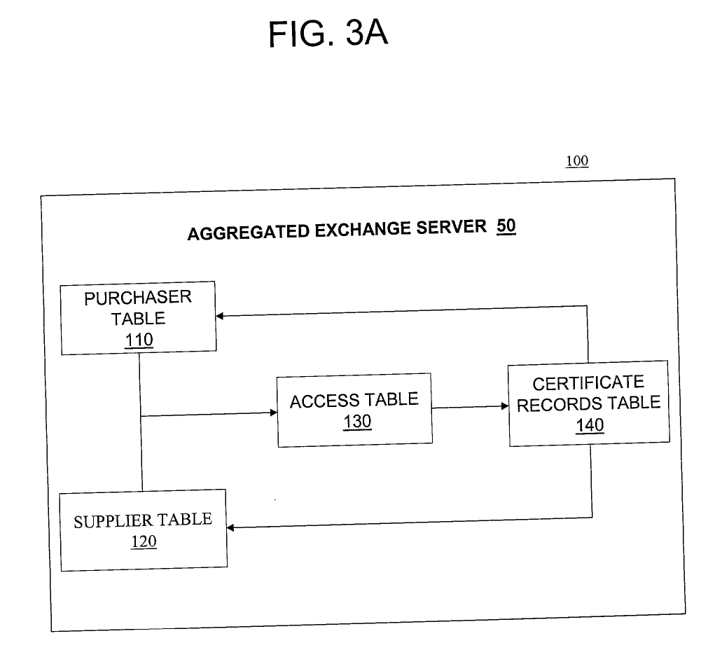

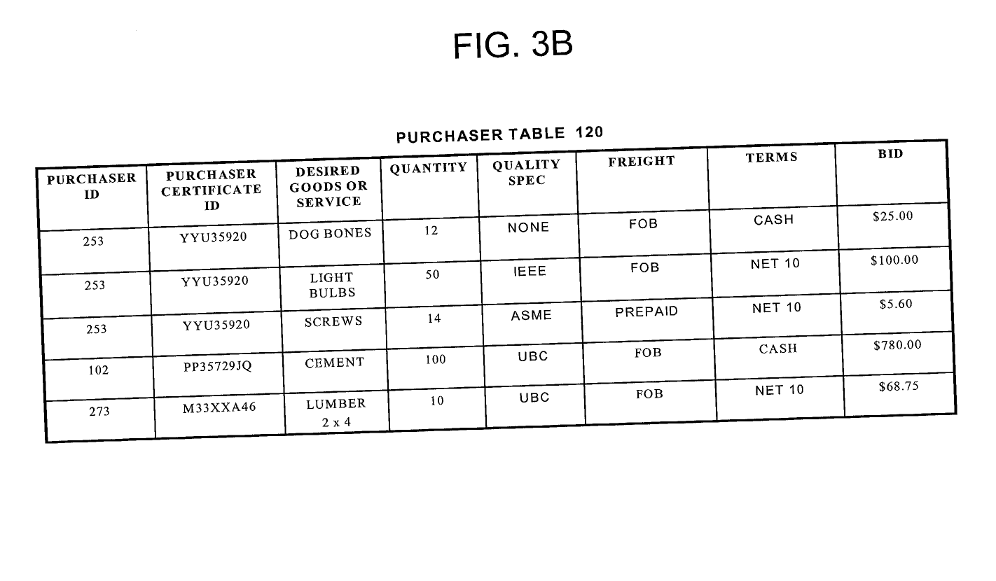

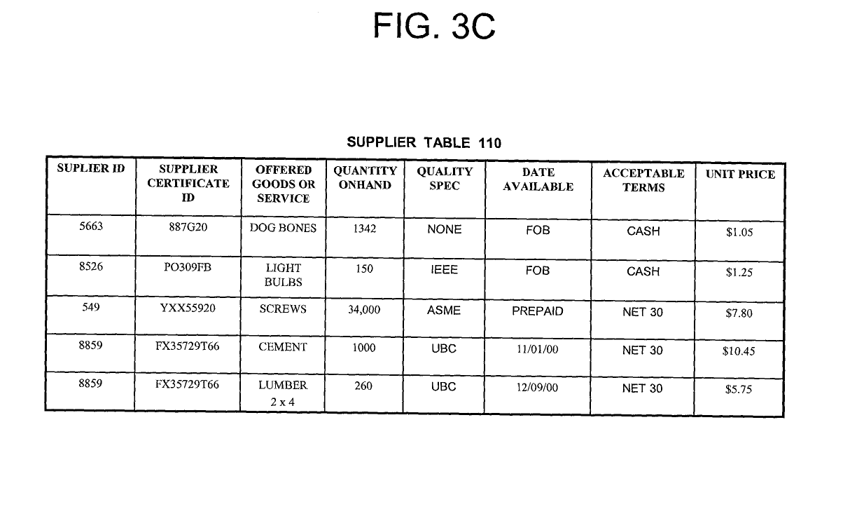

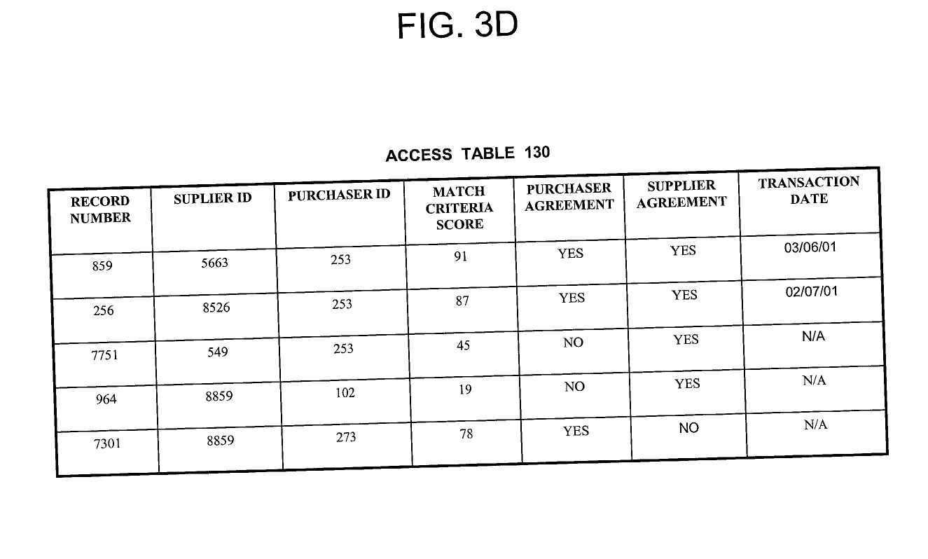

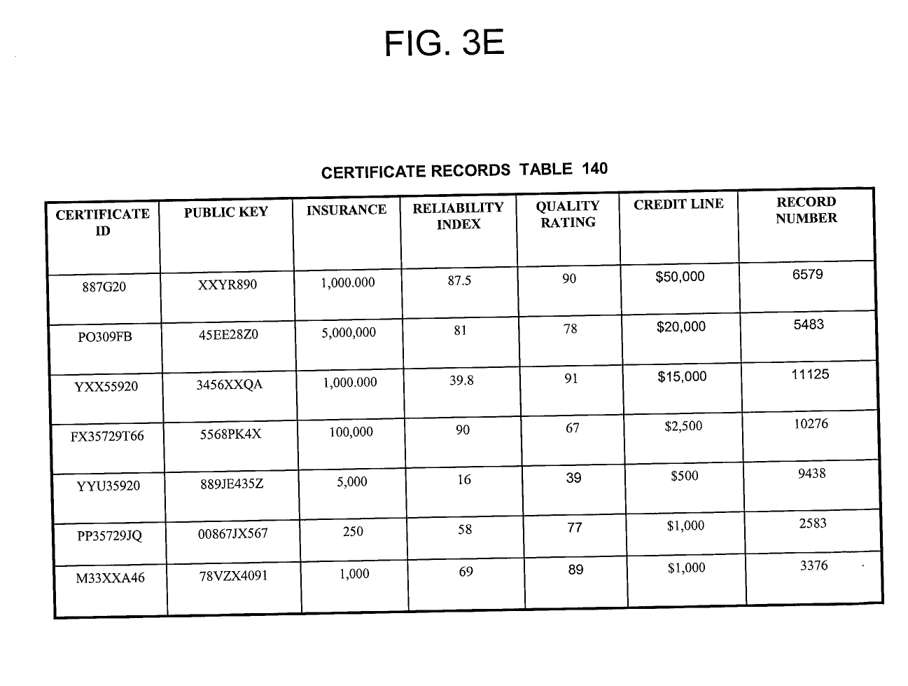

FIG. 3A is a block diagram illustrating one embodiment of a networked aggregate exchange server 50 for providing anonymous on-line transactions 100, in accordance with the invention. The aggregate exchange server 50 may include a purchaser table 110, a supplier table 120, an access table 130, and a certificate records table 140. The aggregated exchange server 50 may store tables for purchaser transaction instructions, supplier transaction instructions, supplier profiles, purchaser account data and purchaser profiles. Additionally, the aggregated exchange server 50 may secure transactional data using extensible mark-up language (XML), public key encryption, cryptography, or by using other security means known in the art. The aggregated exchange server 50 may receive instructions to restrict purchaser transaction information via the Internet 60 from the purchaser node 20. Supplier instructions to restrict supplier transaction information via the Internet 60 may also be received by the aggregated exchange server 50 from the supplier server 30.

In another embodiment of the invention, purchaser and/or supplier instructions may be stored on the aggregate exchange server 50, further restricting access to transaction information retained in the access table 130.

The aggregate exchange server 50 may receive requests for purchaser transaction information and accounting data via the Internet 60 from the supplier server 30 and the certificate authority server 40. The aggregate exchange server 50 may also receive requests for supplier transaction information and accounting data via the Internet 60 from the purchaser node 20 and the certificate authority server 40. The aggregate exchange server 50 may query supplier and purchaser transaction requests in an access table 130. In another embodiment, the aggregate exchange server 50 may have a separate supplier access table and a purchaser access table. In another embodiment, the aggregated exchange server 50 may permit suppliers and purchasers to input data into the certificate records table 140 via the access table 130. Where correlation exists between the purchaser data and the supplier data, the aggregate exchange server 50 may construct an access key (public key) to the certificate records table 140 using any matching techniques known in the art for assembling correlation tables. The exchange server 50 may then format the purchaser transaction information into a readable data format. Subsequently, the aggregate exchange server 50 may use the access key to provide access for at least a portion of the purchaser table 120 to the requesting party by passing decryption data and protocols to the purchaser table 120 by any means known in the art. Subsequently, the aggregate exchange server 50 may transmit the requested purchaser transaction information to the supplier via the Internet 60 to the supplier server 30 or the certificate authority server 40.

In another embodiment, the aggregate exchange server 50 may receive instructions from the purchaser to annotate a portion of the purchaser transaction information using XML to make comments regarding veracity of the data, products received, payments made and discounts applied by a supplier via the Internet 60 from the purchaser node 20.

FIG. 3B, FIG. 3C, FIG. 3D and FIG. 3E illustrate tables for the operation of the networked aggregate exchange server 50 shown in the embodiment of FIG. 3A, to provide anonymous on-line transactions, in accordance with the present invention.

In another embodiment of the invention, the tables of FIG. 3B through FIG. 3E may contain data objects that may be used to associate transaction data, purchaser information, account data, supplier data, server site addresses, physical location identification data for permanent hardcopy files or other elements as required to facilitate association written in extensible mark-up language. These data objects may be well-formed parsed entities containing root entities that may be composed of properly nested declarations, elements, comments, character references, processing instructions, and references to other entities. These entities may be accessed by any combination of public key, digital signature, password or other cryptographic means known in the art which satisfy any validity constraint, well formed constraint or reference requirement nested in the processing instructions.

In another embodiment, the entity may be further encrypted and secured by converting the entity by any encryption algorithm in combination with any public key, digital signature, password or other cryptographic means known in the art to render a non-valid entity incapable of being read by any validating or non-validating XML processors. An example of the XML entities for Transaction is shown below in Table 1.0.

TABLE 1.0
Example of XML Entities

| <TRANSACTION> | |
|---|---|
| <Purchaser ID> | </Purchaser ID> |
| <Desired Product> | </Desired Product> |
| <Date Required> | </Date Required> |
| <Quantity> | </Quantity> |
| <Bid> | </Bid> |
| <Supplier ID> | </Supplier ID> |
| <Product Offered> | </Product Offered> |
| <Quantity> | </Quantity> |
| <Availability> | </Availability> |

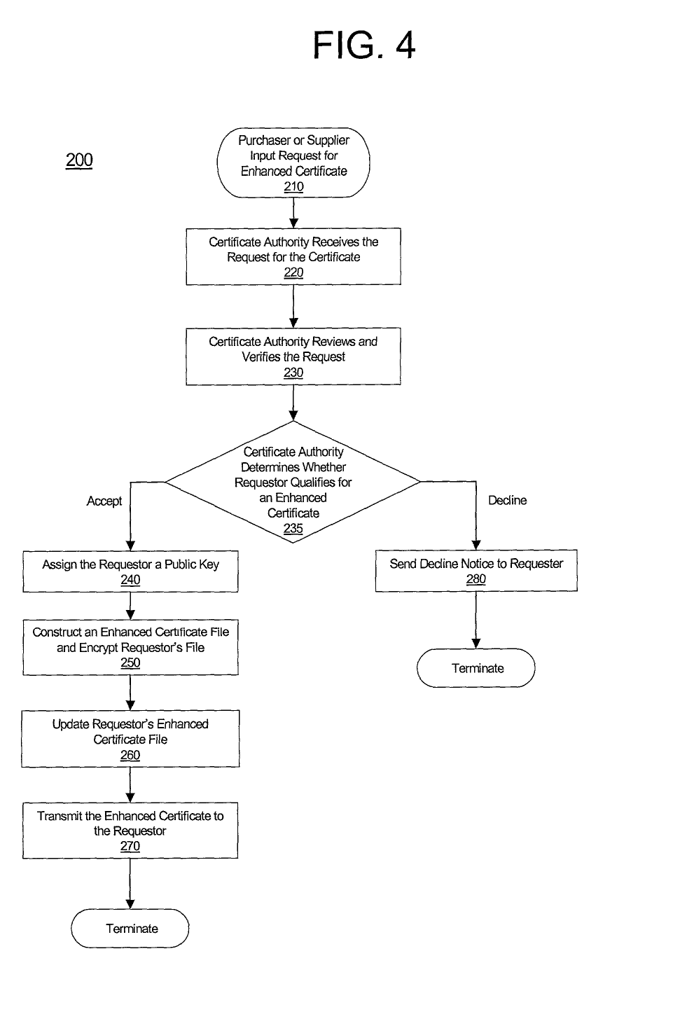

Referring to FIG. 4 one embodiment of a method for restricting access to purchaser and supplier identification information is generally shown at numeral 200. A purchaser or supplier may input instructions requesting an enhanced certificate where the purchaser node 20 or supplier server 30 transmits the instructions over the Internet 60 to the certificate authority server 40 (Block 210). The certificate authority server 40 may receive the purchaser or supplier input requesting an enhanced certificate (Block 220). The certificate authority server 40 may use the purchaser or supplier input to construct a purchaser or supplier certificate ID, and verify the contents of the enhanced certificate (Block 230). Subsequent to constructing and verifying an enhanced certificate, the certificate authority server 40 may determine whether the requesting supplier or purchaser qualifies for the enhanced certificate (Block 235). If determined to qualify for an enhanced certificate, the certificate authority server 40 may assign the requester a public key to be sent to the aggregated exchange server 50 for use in the certificate records table 140 (Block 240). The certificate authority server 40 may then construct an enhanced certificate file associated to the public key, containing encrypted information of the requesting purchaser or supplier (Block 250). The certificate authority server 40 may locate an existing enhanced certificate file in which the newly encrypted information may be amended or updated to the existing enhanced certificate file (Block 260). The health insurer or third party may input a request for purchaser transaction information. This request may be received at the exchange server 50 where the health insurer server 30 may transmit the request via the Internet 60 to the aggregated exchange server 50 (Block 260). The supplier may input a request for purchaser transaction information. This request may be received at the exchange server 50 where the Certificate authority server 40 may transmit the request via the Internet 60 to the aggregated exchange server 50 (Block 260). Upon completion, the certificate authority server 40 may transmit via the Internet, an enhanced certificate 70 to the requesting supplier or purchaser for verification purposes (Block 270). Had the certificate authority server 40 determined that the requesting supplier or purchaser does not qualify for an enhanced certificate (Block 235), the certificate authority server 40 may send a notice of denial to the requesting supplier or purchaser (Block 280).

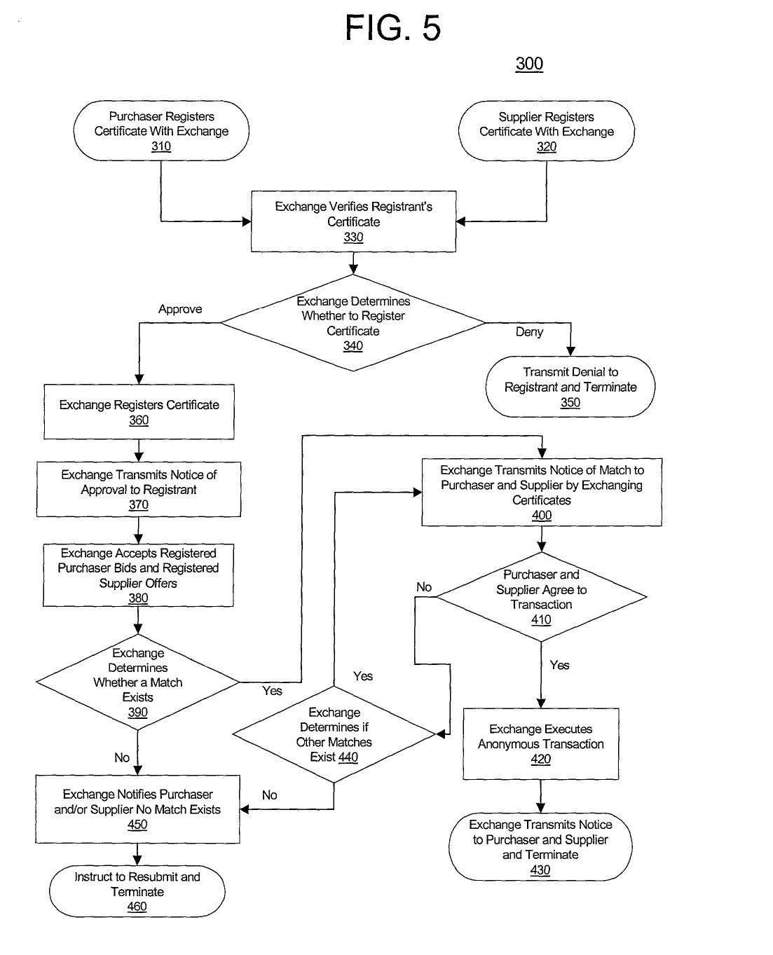

One embodiment of the invention is illustrated by FIG. 5 as a flowchart diagram of a method for conducting an anonymous on-line transaction 300. After a purchaser has registered with the certificate authorization server 40 (Block 310) and a supplier has registered with the certificate authorization server 40 (Block 320), the purchaser and or supplier can pass their enhanced certificate ID to the aggregated exchange server 50. The aggregated exchange server 50 may verify the enhanced certificate ID and purchaser or supplier name with the information restricted to the certificate authority server 40 via the Internet 60 (Block 330). If the aggregated exchange server 50 determines to deny a purchaser or supplier access to the registration process, a notice of denial may be sent to the requesting supplier or purchaser via the Internet 60 (Block 350).

Upon approving a purchaser or supplier access to the registration process (Block 340), the aggregate exchange server 50 may register the purchaser or supplier enhanced certificate ID, and any accompanying data, with the appropriate aggregate exchange server tables (Block 360). A notice of acceptance may be sent to the requesting supplier or purchaser via the Internet 60 (Block 370), authorizing the supplier or purchaser to provide the aggregate exchange server 50 with purchaser bids and supplier offers (Block 380). The aggregate exchange server 50 may then determine whether a purchaser bid and supplier offer match (Block 390). If a match does not exist, the aggregate exchange server 50 may notify the purchaser or supplier that no match exists (Block 450) via the Internet 60, and instruct the purchaser or supplier to resubmit any further response (Block 460).

When a match is found by the aggregate exchange server 50, the purchaser and supplier may be notified of the match by exchanging enhanced certificate ID's (Block 400). If the purchaser and supplier agree to the terms of the transaction (Block 410), the aggregate exchange server 50 may execute the anonymous transaction (Block 420) and a notice to the purchaser and supplier may be sent via the Internet 60 (Block 430). If the purchaser and supplier do not agree to the transaction terms (Block 410), the aggregate exchange server 50 may determine if other matches exist (Block 440). If not, the aggregate exchange server 50 may notify the purchaser or supplier that no match exists (Block 450) via the Internet 60, and instruct the purchaser or supplier to resubmit any further response (Block 460). If another match does exist (Block 440), the aggregate exchange server 50 again provides the purchaser and supplier with a notification of the match by exchanging enhanced certificate ID's (Block 400). This continues until either the purchaser and supplier agree to the terms of the transaction (Block 410), until another match is found and the purchaser and supplier agree to the terms of the transaction (Block 440), or until the purchaser or supplier no longer submit bids or offers (Block 460).

The above-described methods and implementation are example methods and implementations, and are to illustrate one possible approach for providing anonymous on-line transactions. The actual implementation may vary from the method discussed. Moreover, various other improvements and modifications to this invention may occur to those skilled in the art, and those improvements and modifications will fall within the scope of this invention as set forth in the claims below. The present invention may be embodied in other specific forms without departing from its spirit or essential characteristics. The described embodiments are to be considered in all respects only as illustrative and not restrictive.

We claim:

1. A method for performing an anonymous online transaction comprising:
receiving a request for an enhanced certificate from a requestor at a certificate authority server;
determining whether the requester qualifies for the enhanced certificate;
issuing the requestor an enhanced certificate from the certificate authority server if the requester qualifies;
receiving an offer from a supplier with a supplier enhanced certificate at an aggregate exchange server;
receiving a bid from a purchaser with a purchaser enhanced certificate at the aggregate exchange server;
determining whether the bid matches the offer;
sending the supplier the purchaser enhanced certificate from the aggregate exchange server, and sending the purchaser the supplier enhanced certificate from the exchange server, if the bid matches the offer; and
receiving agreement of the matched supplier and purchaser at the exchange server to execute the transaction.

2. The method of claim 1 wherein the certificate authority server comprises the aggregate exchange server.

3. The method of claim 1 wherein the enhanced certificate comprises financial data, credit rating data, financial routing data and identification data.

4. The method of claim 1 wherein issuing the requester an enhanced certificate comprises implementing at least one security feature.

5. The method of claim 4 wherein the security feature is selected from a group consisting of a user password, a public key cryptograph, a digital signature, and an XML based security standard.

6. The method of claim 1 further comprising:
providing a hyperlink to the aggregated exchange server wherein the hyperlink comprises the certificate request.

7. The method of claim 6 wherein the hyperlink is provided on a web site for access by the requestor.

8. The method of claim 1 further comprising:
verifying a portion of requestor financial information with an outside server.

9. The method of claim 8 wherein verifying the portion of requestor financial information comprises determining eligibility for an enhanced certificate.

10. The method of claim 8 further comprising:
updating requestor financial information.

11. A computer usable medium including a program for performing an anonymous online transaction comprising:
computer readable code for receiving a request for an enhanced certificate from a requestor at a certificate authority server;
computer readable code for determining whether the requester qualifies for the enhanced certificate;
computer readable code for issuing the requestor an enhanced certificate from the certificate authority server if the requestor qualifies;
computer readable code for receiving an offer from a supplier with a supplier enhanced certificate at an aggregate exchange server;
computer readable code for receiving a bid from a purchaser with a purchaser enhanced certificate at the aggregate exchange server;
computer readable code for determining whether the bid matches the offer;
computer readable code for sending the supplier the purchaser enhanced certificate from the aggregate exchange server, and sending the purchaser the supplier enhanced certificate from the exchange server, if the bid matches the offer; and
computer readable code for receiving agreement of the matched supplier and purchaser at the exchange server to execute the transaction.

12. The computer usable medium of claim 11 wherein the certificate authority server comprises the aggregate exchange server.

13. The computer usable medium of claim 11 wherein the enhanced certificate comprises financial data, credit rating data, financial routing data and identification data.

14. The computer usable medium of claim 11 wherein issuing the requester an enhanced certificate comprises implementing at least one security feature.

15. The computer usable medium of claim 14 wherein the security feature is selected from a group consisting of a user password, a public key cryptograph, a digital signature, and an XML based security standard.

16. The computer usable medium of claim 11 further comprising:
computer readable code for providing a hyperlink to the aggregated exchange server wherein the hyperlink comprises the certificate request.

17. The computer usable medium of claim 16 wherein the hyperlink is provided on a web site for access by the requester.

18. The computer usable medium of claim 11 further comprising:
computer readable code for verifying a portion of requestor financial information with an outside server.

19. The computer usable medium of claim 18 wherein verifying the portion of requester financial information comprises determining eligibility for an enhanced certificate.

20. The computer usable medium of claim 18 further comprising:
computer readable code for updating requestor financial information.

21. A system for performing an anonymous online transaction comprising:
means for receiving a request for an enhanced certificate from a requester at a certificate authority server;
means for determining whether the requestor qualifies for the enhanced certificate;
means for issuing the requester an enhanced certificate from the certificate authority server if the requestor qualifies;
means for receiving an offer from a supplier with a supplier enhanced certificate at an aggregate exchange server;
means for receiving a bid from a purchaser with a purchaser enhanced certificate at the aggregate exchange server;
means for determining whether the bid matches the offer;
means for sending the supplier the purchaser enhanced certificate from the aggregate exchange server, and means for sending the purchaser the supplier enhanced certificate from the exchange server, if the bid matches the offer; and
means for receiving agreement of the matched supplier and purchaser at the exchange server to execute the transaction.

22. The system of claim 21 further comprising:
means for implementing at least one security feature.

23. The system of claim 21 further comprising:
means for providing a hyperlink to the aggregated exchange server.

24. The system of claim 21 further comprising:
means for verifying a portion of requester financial information with an outside server.

25. The system of claim 24 further comprising:
means for updating requestor financial information.
